(19) United States
(12) Patent Application Publication
(10) Pub. No.: US 2025/0095931 A1
(43) Pub. Date: Mar. 20, 2025

(54) MODULAR ELECTRICAL SWITCH APPARATUS AND ELECTRICAL SWITCH BASE

(71) Applicant: Eaton Intelligent Power Limited, Dublin (IE)

(72) Inventors: Abhishek Pratap Rao, Pune (IN); Somnath Janaba Devarde, Ichalkaranji (IN); Arthur James Jur, Cleveland, TN (US)

(21) Appl. No.: 18/368,385

(22) Filed: Sep. 14, 2023

(51) Int. Cl. H01H 19/14; H01H 19/08

(52) U.S. Cl. CPC H01H 19/14; H01H 19/08

(57) ABSTRACT

An electrical switch apparatus includes: a base including: a first side, a second side opposite the first side, and an opening that passes through the base and is configured to receive a moveable contact assembly; and geometric features on the second side of the base, the geometric features including one or more engagement features that extend from the second side. The one or more engagement features are configured to hold one or more switch components to the base without a separate fastening device.

### TECHNICAL FIELD

This disclosure relates to a modular electrical switch apparatus and an electrical switch base.

### BACKGROUND

An electrical switch includes stationary electrical contacts and a moveable electrical contact. The state of the electrical switch is changed from ON to OFF and OFF to ON by moving the moveable electrical contact relative to the stationary electrical contacts. The stationary electrical contacts may be enclosed in a housing.

### SUMMARY

In one aspect, an electrical switch apparatus includes: a base including: a first side, a second side opposite the first side, and an opening that passes through the base and is configured to receive a moveable contact assembly; and geometric features on the second side of the base, the geometric features including one or more engagement features that extend from the second side. The one or more engagement features are configured to hold one or more switch components to the base without a separate fastening device.

Implementations may include one or more of the following features.

The geometric features may include a first engagement feature and a second engagement feature, the first engagement feature may be configured to hold a first switch component, the second engagement feature may be configured to hold a second switch component. The geometric features may include a third engagement feature configured to hold a third switch component, and a fourth engagement feature configured to hold a fourth switch component. The first switch component may include a first stationary electrical contact, the second switch component may include a second stationary electrical contact, the third switch component may include a first arc chute, and the fourth switch component may include a second arc chute. The first switch component may include a first stationary electrical contact, and the second switch component may include a second stationary electrical contact. The first switch component may include a first arc chute, and the second switch component may include a second arc chute.

The one or more engagement features may interact with the switch component to hold the switch component without a separate fastening device by a frictional engagement, a tight fit, a snap fit, and/or a compression fit between the one or more engagement features and the switch component.

The base may be a first base, and the electrical switch also may include a second base that is identical to the first base. The second base may include: a first side, a second side, and an opening configured to receive the moveable contact assembly. The second side of the second base may include geometric features, the geometric features of the second base including one or more engagement features that extend from the second side of the second base. The geometric features of the first base also may include one or more attachment features that extend from the second side of the first base; the geometric features of the second base also may include one or more attachment features that extend from the second side of the second base; and the one or more attachment members of the first base may be configured to engage with corresponding attachment features of the second base to attach the first base to the second base with the second side of the first base facing the second side of the second base.

In some implementations, when the first base is attached to the second base, a shaft of the moveable electrical contact assembly extends through the opening in the first base and the opening in the second base and is rotatable relative to the first base and the second base; and the switch component is between the second side of the first base and the second side of the second base. The first base and the second base may be made of electrically insulating material.

In another aspect, an electrical switch includes: a base structure including: a first switch base including: a first external surface, a first internal surface, and first geometric features extending from the first internal side, the first geometric features including first attachment features and first engagement features; a second switch base including: a second external surface, a second internal surface, and second geometric features extending from the second internal side, the second geometric features including second attachment features and second engagement features; and at least one switch component in the base structure. The at least one switch component is held by one or more of the first engagement features and the second engagement features, and the first and second attachment features connect to hold the first switch base to the second switch base with the first internal surface facing the second internal surface.

Implementations may include one or more of the following features.

The at least one switch component may be one or more of a first stationary electrical contact, a second stationary electrical contact, a first arc chute, and a second arc chute.

The first switch base and the second switch base may include an opening configured to receive a shaft of a moveable contact assembly. The electrical switch also may include the moveable contact assembly, the shaft may be inserted through the opening of the first switch base and the opening of the second switch base, the moveable electrical contact may extend radially outward from the shaft, and rotating the shaft may rotate the moveable electrical contact along an arc in the base structure. The spatial arrangement of the first geometric features and the spatial arrangement of the second geometric features may align the first stationary contact and the second stationary contact with the moveable contact such that the angular position of the shaft determines whether or not the moveable contact is connected to the first stationary contact and the second stationary contact.

In another aspect, a modular switching system includes: a first single-pole switch base including: a first base body; and first switch components held in the first base body, the first switch components including: a first stationary contact, a second stationary contact, a first arc chute, and a second arc chute; and a first shaft that passes through the first single-pole switch base and is configured to rotate relative to the first base body, the first shaft including a moveable contact that extends radially outward from the shaft and rotates through an arc that intersects the first stationary contact and the second stationary contact. The first single-pole switch base and the first shaft are configured to be connected to one or more other single-pole switch bases that are identical to the first single-pole switch base to form a multi-pole switch.

In some implementations, the first switch components are secured to the first base body only with geometric features internal to the first base body.

Implementations of any of the techniques described herein may include an apparatus, a device, a system, and/or a method. The details of one or more implementations are set forth in the accompanying drawings and the description below. Other features will be apparent from the description and drawings, and from the claims.

### DRAWING DESCRIPTION

FIG. 1A is a block diagram of a switching system that includes a switch apparatus.

FIG. 1B is a block diagram of the switch apparatus of FIG. 1A.

FIGS. 1C-1E show various views of a base structure in a disassembled state.

FIGS. 1F-1H show various positions of a moving contact of a double make, double break switch.

FIGS. 2A and 2B are perspective views of an interior side of a switch base.

FIG. 3 is an example of switch components secured in a switch base.

FIG. 4 is another example of switch components secured in a switch base.

FIG. 5 is a perspective view of a moveable contact assembly.

FIG. 6 is a perspective view of a switch base and the moveable contact assembly of FIG. 5.

FIG. 7 is a perspective exploded view of a switch apparatus.

FIG. 8 is a perspective view of the exterior of the switch apparatus of FIG. 7 in an assembled state.

FIG. 9A shows a three-pole switch being formed by stacking three single-pole switch apparatuses.

FIG. 9B shows an assembled three-pole switch.

### DETAILED DESCRIPTION

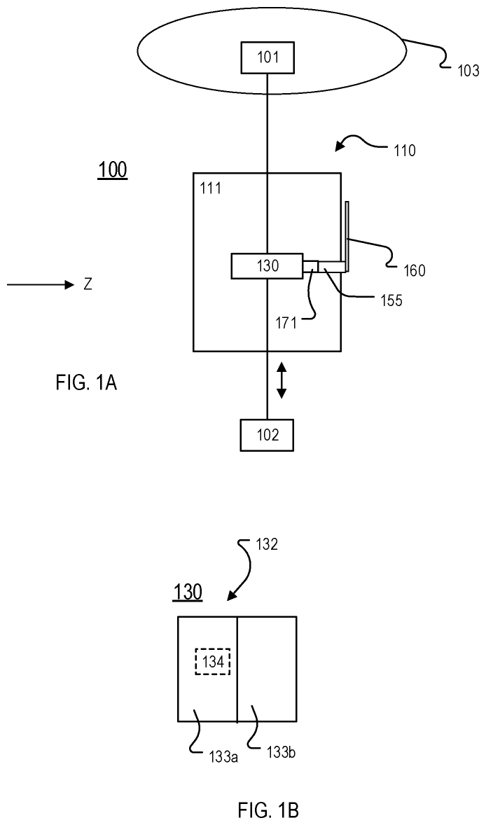

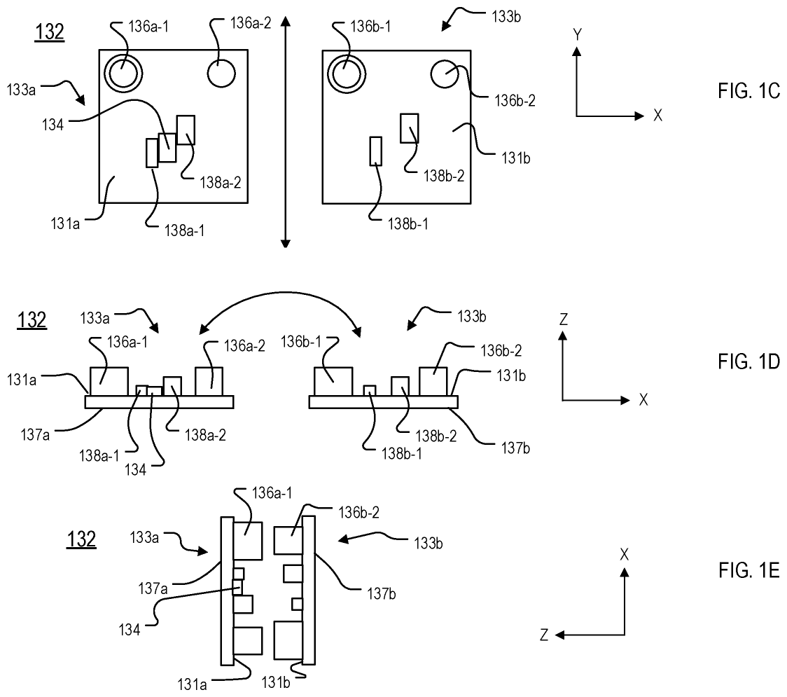

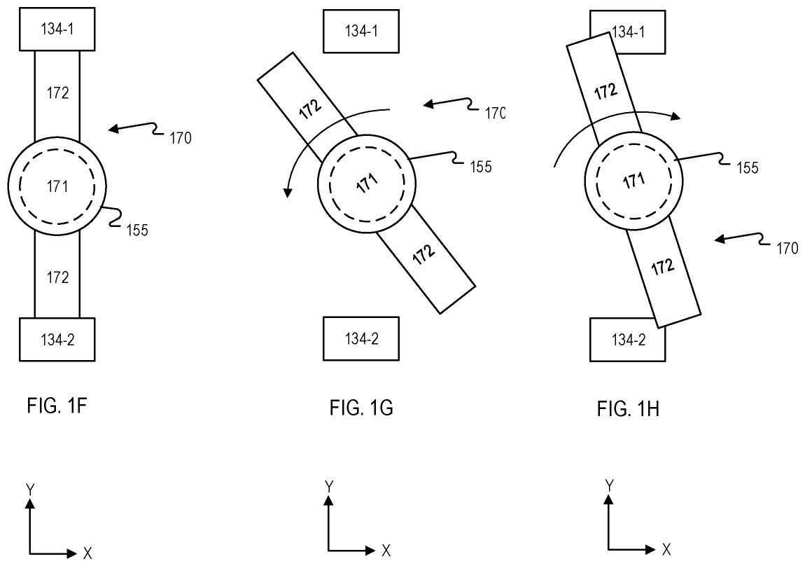

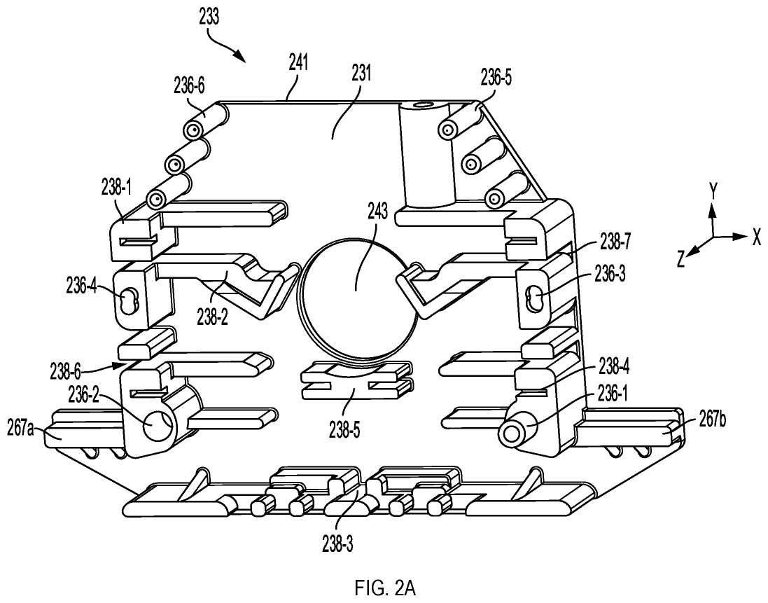

FIG. 1A is a block diagram of a switching system 110 that is between a source 101 and a load 102. The switching system 110 may be, for example, a safety switch, a shunt trip safety switch, or a molded case circuit breaker. The switching system 110 includes a switch apparatus 130. As discussed below, the switch apparatus 130 is configured in a manner that promotes efficient assembly and reduces or eliminates separate fastening and securing mechanisms. The switch apparatus 130 also may be joined to one or more other identical switch apparatus(s) to build a switch system with a specific current rating. In this way, the switch apparatus 130 provides a modular building block for building a larger switch system having a current rating appropriate for a particular application.

Referring also to FIG. 1B, which is a block diagram of the switch apparatus 130 in the assembled state, the switch apparatus 130 includes a base structure 132 and switch components 134. The base structure 132 is a housing for a single-pole switch that is constructed from two half portions: a first switch base 133a and a second switch base 133b. The switch components 134 include one or more items used in the operation of the switch apparatus 130. The switch components 134 may include, for example, stationary contacts and/or arc chutes.

Referring also to FIGS. 1C-1E, which show various views of the base structure 132 in a disassembled state, each switch base 133a, 133b includes geometric features that extend from a respective interior side 131a, 131b in the Z direction. Each switch base 133a, 133b also includes a respective exterior side 137a, 137b that is opposite the respective interior side 131a, 131b.

The geometric features include attachment features 136a-1, 136a-2, 136b-1, 136b-2 (collectively called the attachment features 136) and engagement features 138a-1, 138a-2, 138b-1, 138b-2 (collectively called the engagement features 138). In the example shown in FIGS. 1C and 1D, the attachment features 136a-1 and 136b-1 are posts with a cylindrical recess, and the attachment features 136a-2 and 136b-2 are posts that are slightly smaller than the cylindrical recess.

The switch bases 133a, 133b are identical. To assemble the base structure 132, the switch bases 133a, 133b are positioned in the X-Y plane with the same orientation, as shown in FIG. 1C. The switch base 133a and/or the switch base 133b are rotated about the Y axis and aligned with the interior sides 131a and 131b face each other, as shown in FIG. 1E. The switch bases 133a and 133b are moved toward each to insert the attachment feature 136b-2 (a post in this example) into the recess of the attachment feature 136a-1 and the attachment feature 136a-2 into the recess of the attachment feature 136b-1. The connected attachment features 136 hold the switch bases 133a, 133b together, and the base structure 132 (FIG. 1B) is formed.

The attachment features 136a-1, 136a-2 on the switch base 133a hold the respective attachment features 136b-2, 136b-1 on the switch base 133b without using separate securing hardware or mechanisms that are not part of the switch base 133a, 133b. Examples of separate securing mechanisms include, for example, screws, bolts, and rivets. Instead of using separate securing mechanisms, the attachment features 136 on the switch base 133a are configured to hold the attachment features 136 on the switch base 133b through a physical interaction between two connected or joined attachment features 136. Examples of the physical interaction include, for example, a tight fit, an interference fit, a snap fit, a compression fit. The attachment features 136 may be the sole mechanism by which the switch bases 133a and 133b are secured to each other.

Similarly, the engagement features 138 are the only mechanism used to hold the switch components 134 in the base structure 132. The engagement features 138 hold the switch components 134 in the base structure 132 by applying force to the switch components 134. Examples of the force include, for example, a tight fit, a compression fit, an interference fit, and a snap fit between one of the switch components 134 and one or more of the engagement features 138.

This approach for constructing the base structure 132 is in contrast to some legacy switches that rely on separate fastening mechanisms such as adhesives, screws, and/or bolts to hold a switch housing together and to secure components in the switch housing. Therefore, as compared to such legacy switches, the base structure 132 includes fewer parts and is easier and more efficient to assemble. Moreover, the spatial arrangement of the engagement features 138 ensures that the switch components 134 can be easily and properly positioned within the base structure 132.

Additionally, each base structure 132 is independent and may be connected to other base structures to achieve higher current ratings. For example, the base structure 132 may be connected to one or more identical base structures 132 to form a multi-pole switch. That is, two separate instances of the base structure 132 may be connected together to form a two-pole switch, three separate instances of the base structure 132 may be connected together to form a three-pole switch, and so on.

Before discussing example implementations of the switch apparatus 130 in more detail, an overview of various components of the source 101, the load 102, the switching system 110, and the switch apparatus 130 is provided.

The source 101 is any kind of AC power source. For example, the source 101 may be a generator, a power plant, a distributed energy resource (DER), or a node or feeder in an AC power grid. A DER is an electricity-producing resource and/or a controllable load. Examples of DERs include, without limitation, solar-based energy sources such as, for example, solar panels and solar arrays; wind-based energy sources, such as, for example, wind turbines and windmills; combined heat and power plants; rechargeable sources (such as batteries); natural gas-fueled generators; electric vehicles; and controllable loads, such as, for example, some heating, ventilation, air conditioning (HVAC) systems, and electric water heaters.

The load 102 is any device or system that consumes, transfers, absorbs, and/or produces electrical power. For example, the load 102 may be a motor; a lighting system; a distributed energy resource (DER); an uninterruptable power supply, a capacitor, a power-factor correction device (such as a capacitor bank), or a transformer. The load 102 may be located at a customer site, such as, for example, a residence or an industrial facility. The load 102 may include more than one device.

In the example of FIG. 1A, the source 101 is part of a grid or electrical power distribution network 103. The electrical power distribution network 103 may be, for example, a multi-phase electrical power grid that provides electricity to industrial, commercial, and/or residential customers. The AC electrical power distribution network 103 distributes AC electrical power that has a fundamental frequency of, for example, 50 or 60 Hertz (Hz). The AC electrical power distribution network 103 may be low-voltage (for example, up to 1 kilovolt (kV)), medium-voltage or distribution voltage (for example, between 1 kilovolts (kV) and 35 kV), or high-voltage (for example, 35 kV and greater).

The distribution network 103 may include more than one sub-grid or portion. For example, the distribution network 103 may include AC micro-grids, AC area networks, or AC spot networks that serve particular customers. These sub-grids may be connected to each other via switches and/or other devices to form the network 103. Moreover, sub-grids within the network 103 may have different nominal voltages. For example, the network 103 may include a medium-voltage portion connected to a low-voltage portion through a distribution transformer.

All or part of the network 103 may be underground. The network 103 may include additional components and devices such as, for example, one or more transmission lines, distribution lines, power distribution or substation transformers, electrical cables, and/or any other mechanism for transmitting electricity.

The switch apparatus 130 has at least two stable states: an ON or closed state in which the switch apparatus 130 conducts current, and an OFF or open state in which the switch apparatus 130 cannot conduct current. In some implementations, the switch apparatus 130 has more than two stable states. For example, the switch apparatus 130 may have three stable states: ON, OFF, and TRIP. In the TRIP state, the switch apparatus 130 cannot be placed in the ON state without first moving an operating interface 160 to the OFF position. The switch apparatus 130 has three functions: make, carry, and break. When the switch apparatus 130 is ON, the switching system 110 electrically connects the source 101 and the load 102. When the switch apparatus 130 is OFF, the load 102 is disconnected from the source 101.

The switch apparatus 130 is any type of switch that has an ON state and an OFF state. For example, the switch apparatus 130 may be a double make, double break switch that includes a moveable conductor and that interacts with two stationary contacts. FIGS. 1F-1H show an example of such an implementation. FIG. 1F shows a moveable contact assembly 170 that may be used with the base structure 132 and stationary contacts 134-1 and 134-2. The stationary contacts 134-1 and 134-2 are examples of switch components 134 that are held in the switch base 133a and/or 133b.

The moveable contact assembly 170 includes an axle 171 and an electrical conductor 172 that extends radially outward from the axle 171. In some implementations, the electrical conductor 172 is a single conductive bar or blade that extends though the axle 171. The conductor 172 is mounted to the axle 171 and the conductor 172 rotates with the axle 171.

Referring again to FIG. 1A, the operating interface 160 that is used to control the state of the switch apparatus 130 and the switching system 110. The operating interface 160 is any type of interface that has at least two stable states or positions and is accessible from an exterior of the housing 111. For example, the operating interface 160 may be a handle that moves through a range of motion between two endpoints but is only stationary at the endpoints, where one endpoint corresponds to the switch apparatus 130 being in the OFF state and the other endpoint corresponds to the switch apparatus 130 being in the ON state. In these implementations, the switching system 110 is a single-throw safety switch.

The operating interface 160 is coupled to a hub 155, which is coupled to the axle 171 of the moveable contact assembly 170. The hub 155 rotates in response to a change in the position or state of the operating interface 160. Thus, changing the state or position of the operating interface 160 rotates the axle 171 such that the operating interface 160 also controls the state of the switch apparatus 130.

Referring to FIG. 1F, when the switch apparatus 130 is ON or closed, the conductor 172 is in contact with the stationary contacts 134-1 and 134-2, the switch apparatus 130 has the carry function, and electricity can flow between the source 101 and the load 102. Referring to FIG. 1G, when the state of the switch apparatus 130 is changed from ON to OFF by controlling the operating interface 160, the hub 155 rotates the axle 171 counterclockwise in the X-Y plane and the conductor 172 separates from the stationary contacts 134-1 and 134-2. This breaks the electrical connection between the source 101 and the load 102. When the operating interface 160 is controlled to change the state of the switch apparatus 130 from OFF to ON (FIG. 1H), the hub 155 rotates the axle 171 clockwise in the X-Y plane until the conductor 172 contacts the stationary contacts 134-1 and 134-2, establishing the electrical connection between the source 101 and the load 102. This is the make function of the switch apparatus 130.

The switching system 110 may include more than one instance of the switch apparatus 130 such that each of a plurality of phases is associated with one switch apparatus 130 and the switching system 110 is a multi-phase switch. Each switch apparatus 130 is capable of interrupting current having an amplitude that is appropriate for the application of the switching system 110. The rating of the switching system 110 may be, for example, 30 Amperes (A), 60 A, 100 A, 200 A, 400 A, 600 A, 800 A, 1200 A, or greater.

The switching system 110 also may include a fuse holding assembly (not shown). The fuse holding assembly is any type of assembly that holds fuses. For example, the fuse holding assembly may be one or more fuse clips. The fuse holding assembly may be configured to allow removal and replacement of a fuse that has operated. In implementations that include a fuse holding assembly, the switching system 110 may be shipped or transported without the fuses and the fuses may be installed by the end-user or manufacturer. However, switching system 110 may be used without fuses and may be constructed without a fuse holding assembly.

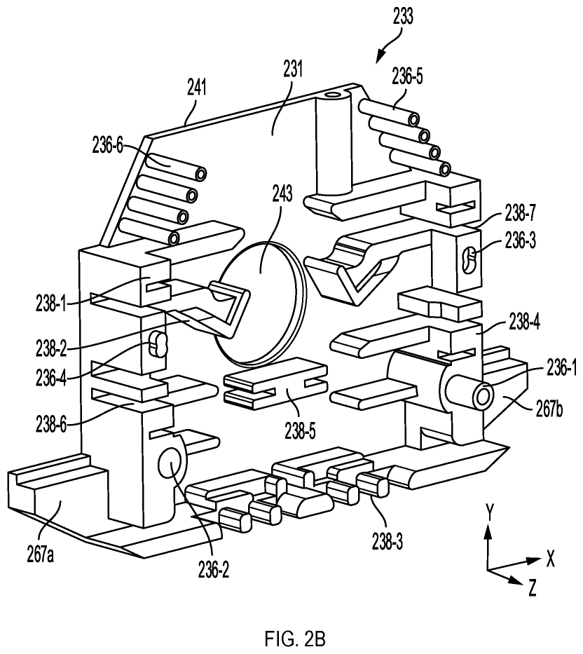

FIGS. 2A and 2B are perspective views of an interior side 231 of a switch base 233. The switch base 233 is used with a second, identical switch base to form a base structure. The switch base 233 includes a base portion 241. The interior side 231 extends in the X-Y plane on the base portion 241. The base portion 241 also has an exterior side (not shown) that extends in the X-Y plane and is opposite to the interior side 231. The base portion 241 defines an opening 243 that passes through the base portion 241 in the Z direction.

The switch base 233 also includes geometric features that extend from the interior side 231 in the Z direction. The geometric features include attachment features 236 and engagement features 238. The attachment features 236 connect with attachment features on a separate, identical switch base to form a base structure. In the example of FIGS. 2A and 2B, the attachment features 236 include a cylindrical attachment post 236-1, a cylindrical recess 236-2, an oval recess 236-3 and an oval post 236-4, a post 236-5, and a post receptacle 236-6.

The engagement features 238 are used to hold switch components to the switch base 233. The engagement features include a first slotted block 238-1, a block locating feature 238-2, a bounded recess 238-3, a second slotted block 238-4, a securing block 238-5, a securing recess 238-6 that is between two blocks, and a securing recess 238-7.

The switch base 233 is a single piece of resilient, electrically insulating material. For example, the switch base 233 may be a single piece of plastic or a polymer. Additional examples of materials that the switch base 233 may be made from include, without limitation, glass-polyester and thermoset composite resins. The switch base 233 may be formed by, for example, injection molding, extrusion, or an additive manufacturing process such as three-dimensional printing. The attachment features 236 and the engagement features 238 are an integral part of the switch base 233 and are spatially fixed relative to each other on the interior side 231.

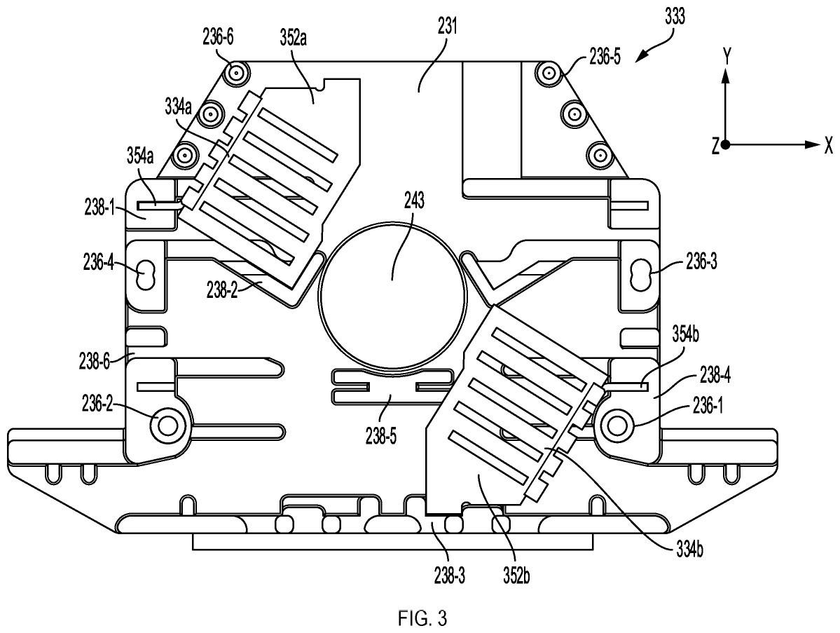

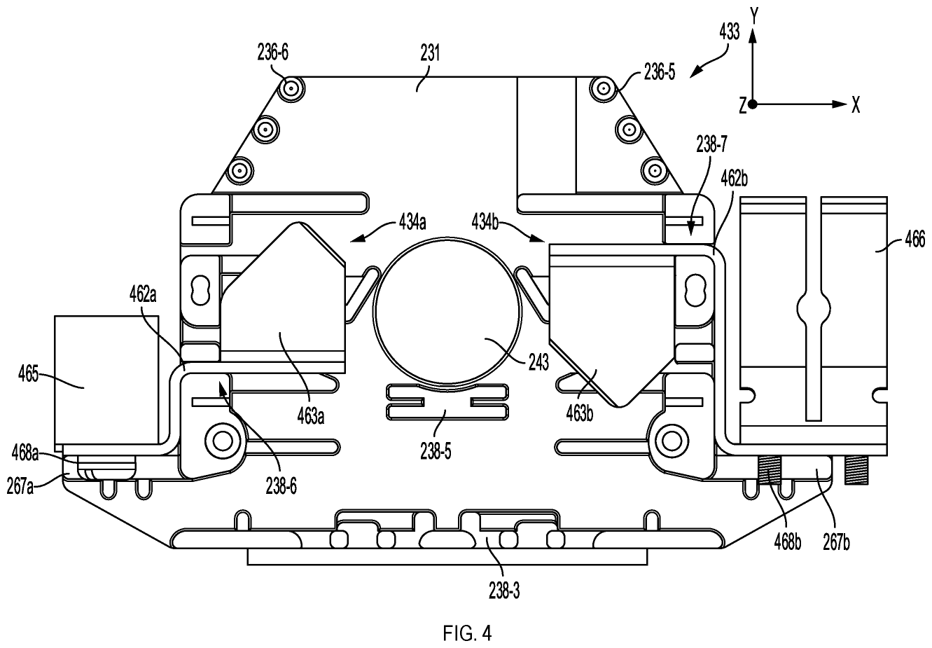

FIG. 3 is an example of switch components secured in a switch base 333. FIG. 4 is an example of switch components secured in a switch base 433. The switch bases 333 and 433 are identical to the switch base 233 and have the same features of the switch base 233.

FIG. 3 is a top view of the switch base 333 and arc chutes 334a, 334b in the X-Y plane. The arc chutes 334a, 334b are switch components and are held in the switch base 333 by various engagement features 238. In the example shown in FIG. 3, arc chute 334a is held in the switch base 333 by the first slotted block 238-1 and the block locating feature 238-2, and the arc chute 334b is held in the switch base 333 by the bounded recess 238-3 and the second slotted block 238-4.

Each arc chute 334a, 334b is a metal structure that includes a respective body 352a, 352b and a flange 354a, 354b that extends from the body 352a, 352b. The bodies 352a, 352b are three-dimensional cage-like structures that contain and/or extinguish arcs. The flange 354-1 is inserted into the first slotted block 238-1 with the body 352a against the block locating feature 238-2. The slot opening in the first slotted block 238-1 engages with the flange 354-1 to secure the arc chute 334a to the switch base 333. The walls of the slot opening in the first slotted block 283-1 may interact with the flange 354-1 with, for example, a frictional engagement, a tight fit, a snap fit, and/or a compression fit. The block locating feature 238-2 also interacts with the arc chute 334a and further secures the arc chute 334a in place. Moreover, the shape and orientation of the block locating feature 238-2 and the positioning of the block locating feature 238-2 relative to the first slotted block 283-1 ensures that the arc chute 334a is properly positioned on the switch base 333.

To secure the arc chute 334b to the switch base 333, the flange 354b is inserted into the opening in the second slotted block 238-4, a tip portion of the body 352b is inserted into the bounding recess 238-3, and the body 352b is wedged between the securing block 238-5 and second slotted block 238-4. The walls of the slot opening of the second slotted block 238-4 hold the flange 354b and the walls that define the bounding recess 238-3 hold the tip of the body 352b such that the arc chute 334b is secured in the switch base 333. The interaction between the walls of the slotted block 238-4 and walls of the bounding recess 238-3 may be, for example, a frictional engagement, a tight fit, a snap fit, and/or a compression fit. The relative positions of the slotted block 238-4 and the bounding recess 238-3 also ensure that the arc chute 334b is properly positioned on the switch base 333.

The arc chutes 334a, 334b are held in the switch base 333 by the engagement features 238 and without the use of separate securing mechanisms. Although in some implementations, additional and/or other engagement features 238 that are an integral part of the switch base 333 may be used to secure the arc chutes 334a, 334b, securing mechanisms that are not an integral part of the switch base 333 are not necessary to secure the arc chutes 334a, 334b to the switch base 333. For example, screws, later-applied adhesives or setting agents, and bolts are necessarily used to secure the arc chutes 334a, 334b to the switch base 333.

FIG. 4 is a top view of the switch base 433 and stationary contacts 434a and 434b in the X-Y plane. The stationary contacts 434a and 434b are switch components that are secured to the switch base 433 by the engagement features 238. The stationary contacts 434a, 434b are electrodes or contacts that are made of an electrically conductive material such as, for example, brass, aluminum, copper, gold or silver. The stationary contact 434a includes an electrically conductive lead 462a that extends from a contact body 463a. The stationary contact 434b includes an electrically conductive lead 462b that extends from a contact body 463b.

The electrical contact 434a is secured in the switch base 433 by inserting the lead 462a into the securing recess 238-6. The securing recess 238-6 holds the lead 462a by, for example, an interference fit, a compression fit, or a tight fit. The electrical contact 434b is secured in the switch base 433 by inserting the lead 462b into the securing recess 238-7. The securing recess 238-7 holds the lead 462b by, for example, an interference fit, a compression fit, or a tight fit and without separate securing mechanisms.

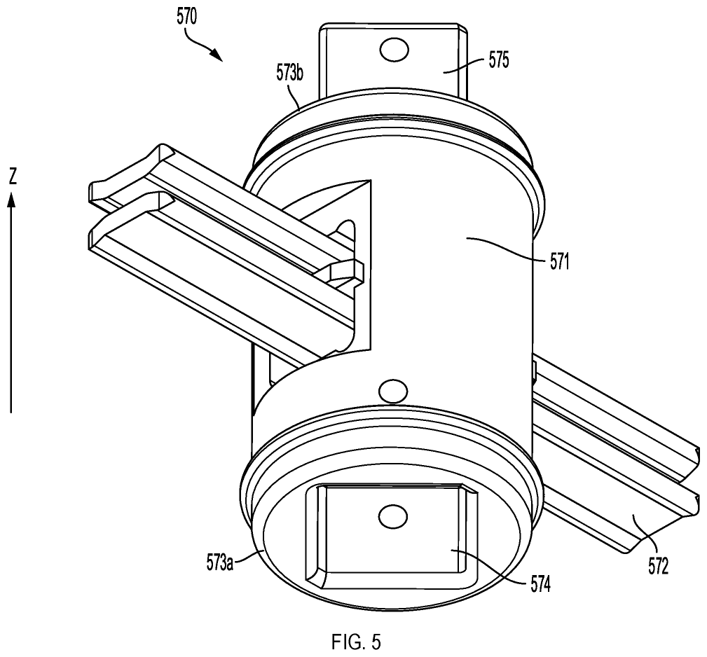

The lead 462a is electrically connected to a line-side contact 465, and the lead 462b is electrically connected to a load-side contact 466. The contacts 465 and 466 are electrically conductive contacts. In the example shown in FIG. 4, the line-side contact 465 is a lug, and the load-side contact 466 is a fuse clip. The load-side contact 466 is used to connect a switch apparatus that includes the switch base 433 to a load (such as the load 102 of FIG. 1A). The line-side contact 465 is used to connect the switch apparatus to a source (such as the source 101). The contacts 465, 466 are fastened with the respective stationary contact 434a, 434b and these sub-assemblies are held in the switch base 433 by various engagement features 238. Separate fastening mechanisms 468a and 468b also may be used but are not necessary. The separate fastening mechanisms 468a and 468b may be, for example, screws, washers, and/or bolts. FIG. 5 is a perspective view of a moveable contact assembly 570. The moveable contact assembly 570 may be used with a base structure formed by joining two instances of the switch base 233. The moveable contact assembly 570 includes an axle 571 and a conductor 572 that extends through the axle 571. The axle 571 extends in the Z direction from an end 573a to an end 573b. The conductor 572 extends in a direction that is substantially perpendicular to the Z direction such that the ends of conductor 572 extend radially outward from the axle 571. The conductor 572 is an electrically conductive bar that is secured to the axle 571 and rotates with the axle 571.

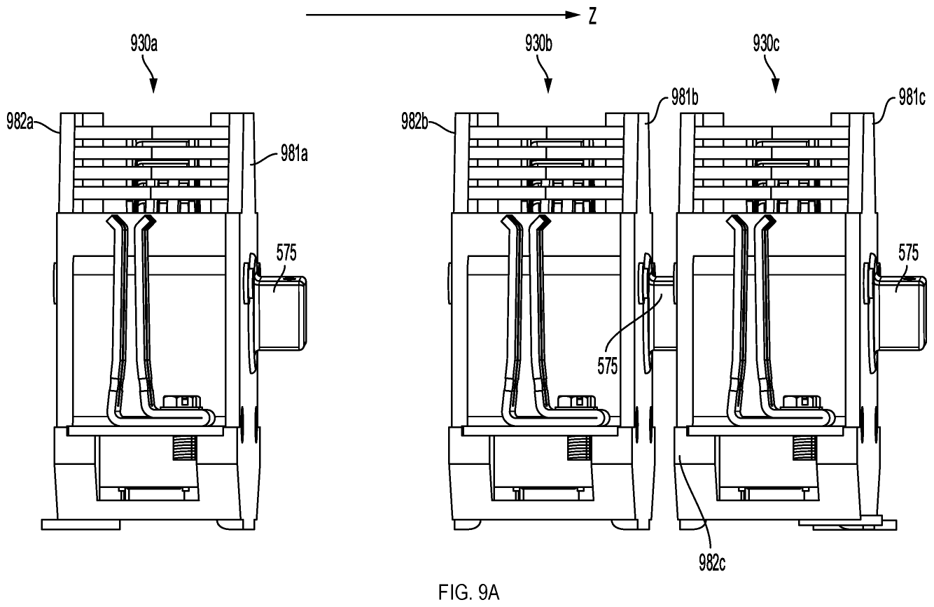

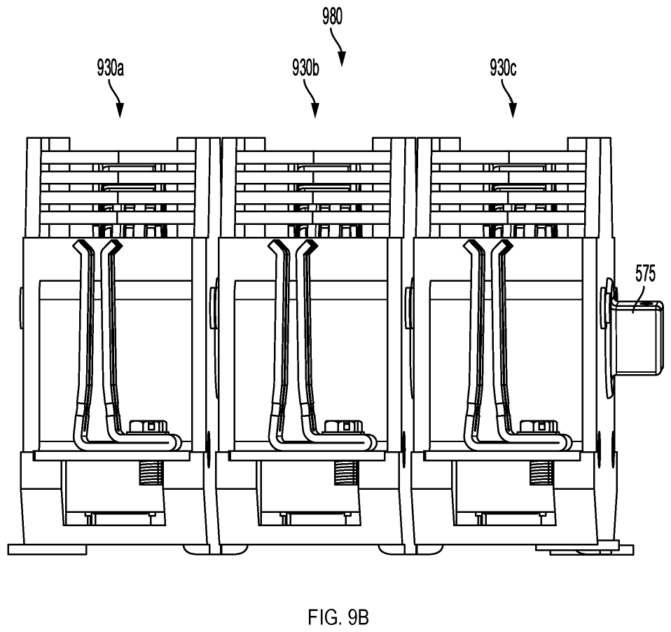

The moveable contact assembly 570 includes a recess 574 in the end 573a and a protrusion 575 that extends from the end 573b of the axle 571 in the Z direction. The recess 574 is shaped and sized to hold the protrusion 575. For example, if the protrusion 575 is a square-shaped block, the recess 574 is a square-shaped recess that can receive and hold the protrusion 575. The recess 574 and the protrusion 575 allow the moveable contact assembly 570 to be connected to one or more other moveable contact assemblies, such as shown in FIGS. 9A and 9B.

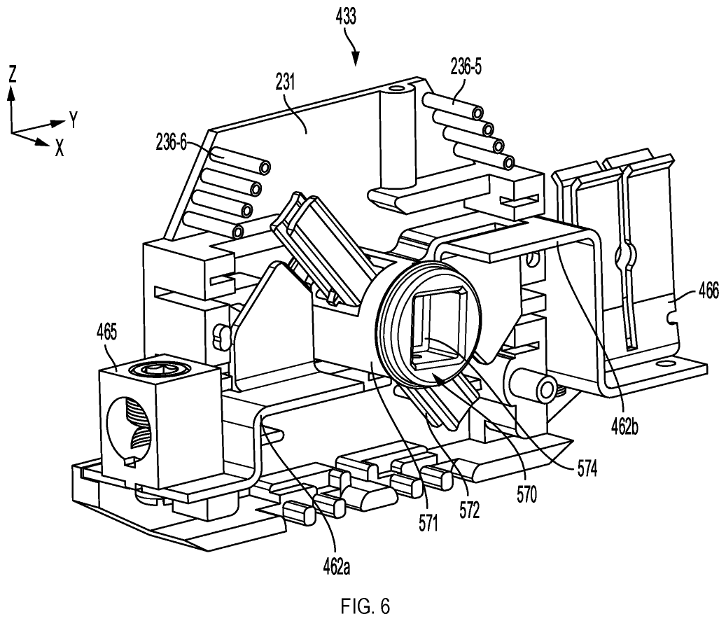

FIG. 6 is a perspective view of the switch base 433 and the moveable contact assembly 570. The moveable contact assembly 570 is attached to the switch base 433 by inserting the end 573b of the axle 571 into the opening 243. When the moveable contact assembly 570 is attached to the switch base 433, the axle 571 can rotate in the opening 243 and the conductor 572 is in a plane that includes a surface of the stationary contacts 434a and 434b. Moreover, the stationary contacts 434a and 434b are aligned with each other such that the conductor 572 either contacts both stationary contacts 434a, 434b or neither stationary contact 434a, 434b. In other words, in addition to securing the stationary contacts 434a and 434b in the switch base 433, the spatial arrangement of the engagement features 238 also ensures that the stationary contacts 434a and 434b are properly aligned with each other and the conductor 572.

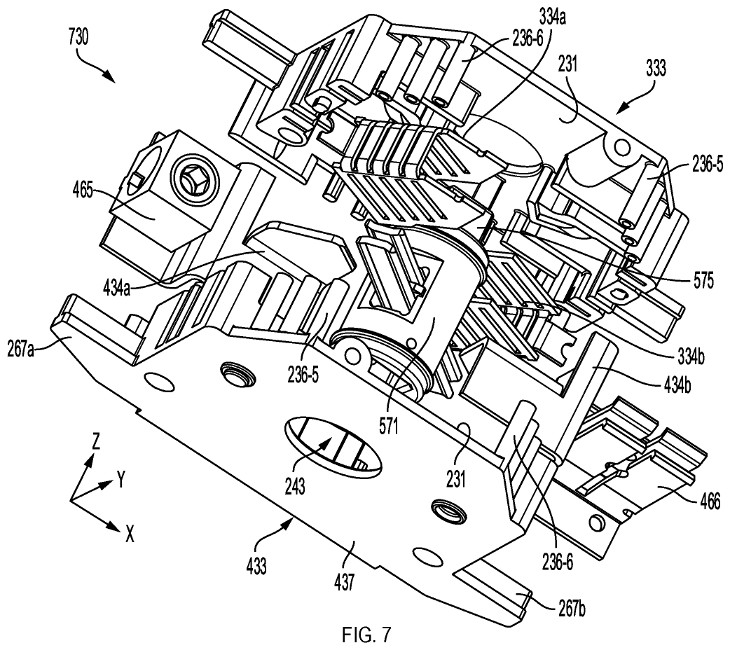

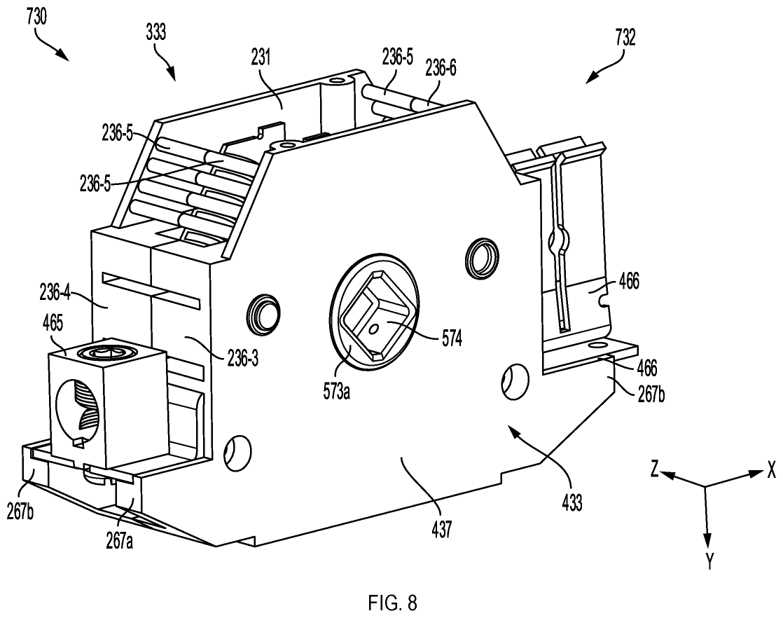

FIGS. 7 and 8 show a switch apparatus 730. FIG. 7 is a perspective exploded view of the switch apparatus 730. FIG. 8 is a perspective view of the exterior of the assembled switch apparatus 730. The switch apparatus 730 includes the switch base 333, the switch base 433, and the moveable contact assembly 570. As discussed above, the switch base 333 and the switch base 433 are identical. The switch base 333 is positioned with its interior side 231 facing the interior side 231 of the switch base 433. The arc chutes 334a and 334b are held in the switch base 333 by the engagement features 238, as discussed with respect to FIG. 3. The stationary contacts 434a and 434b are held in the switch base 433 by the engagement features 238, as discussed with respect to FIGS. 4 and 6. The spatial arrangement of the engagement features 238 also ensures that the arc chutes 334a and 334b are positioned in an optimal manner relative to the stationary contacts 434a and 434b. For example, the arc chutes 334a and 334b may be positioned to receive arcs that may form when the conductor 572 separates from the stationary contacts 434a and 434b.

The axle 571 of the moveable contact assembly 570 is inserted in the opening 243 of each switch base 333 and 433. The axle 571 extends along the Z axis between the switch base 433 and the switch base 333, with the protrusion 575 extending through the opening 243 of the switch base 333 and the recess 574 being accessible from an exterior side 437 of the switch base 433.

The switch base 333 is secured to the switch base 433 with the attachment features 236 to form a base structure 732. For example, the attachment feature 236-5 of the switch base 333 connects to the attachment feature 236-6 of the switch base 433, and the attachment feature 236-5 of the switch base 433 connects to the attachment feature 236-6 of the switch base 333. The attachment feature 236-3 of the switch base 333 is connected to the attachment feature 236-4 of the switch base 433, and the attachment feature 236-3 of the switch base 433 is attached to the attachment feature 234-4 of the switch base 333. These connection points are provided as examples, and other attachment features of the switch base 333 and the switch base 433 also may be connected to each other. However, separate securing mechanisms are not necessarily used to secure the switch base 333 and the switch base 433 to each other. Instead, the physical interaction and contact between the attachment features 236 of the switch base 333 and the attachment features 236 of the switch base 433 are sufficient to secure the switch bases 333 and 433 to each other.

Furthermore, the base structure 732 may be intentionally disassembled by pulling the switch bases 333 and 433 apart with force that is sufficient to overcome the force exerted by the attachment features 236. Pulling the switch bases 333 and 433 apart in this manner does not damage the switch bases 333 and 433. The base structure 732 may be disassembled, for example, to replace switch components or add additional switch components and then reassembled.

Additionally, as shown in FIG. 8, the arrangement of the attachment features 236 on the switch base 333 and the switch base 433 is such that openings exist in the sides of the base structure 732. These openings may facilitate air flow through the base structure 732 and may improve thermal management and the overall operation of the switch apparatus 730. However, the openings in the sides of the base structure 732 are not necessary, and the attachment features 236 may be arranged such that the base structure 732 is a mostly or completely closed structure.

FIGS. 9A and 9B relate to a three-pole switch 980 formed by joining three single-pole switch apparatuses 930a, 930b, 930c. Each switch apparatus 930a, 930b, 930c is an instance of the switch apparatus 730. Each switch apparatus 930a, 930b, 930c includes an instance of the moveable contact assembly 570.

A protrusion 575 extends from a respective top end 981a, 981b, 981c of each switch apparatus 930a, 930b, 930c and a recess 574 (not shown in FIGS. 9A and 9B) is accessible from a respective bottom end 982a, 982b, 982c of each switch apparatus 930a, 930b, 930c. The protrusion 575 of the switch apparatus 930b is inserted into the recess 574 of the switch apparatus 930c to join the switch apparatuses 930c and 930b. The protrusion 575 of the switch apparatus 930a is inserted into the recess 574 of the switch apparatus 930b to join the switch apparatus 930a to the switch apparatus 930b and 930c.

In some implementations, a separate fastener may be used provide additional rigidity to the three-pole switch 980. For example, in some implementations, the attachment features 236-1 and 236-2 is or includes an opening. In these implementations, after aligning the switch apparatuses 930a, 930b, 930c by inserting the protrusion 575 of one switch apparatus into the recess 574 of an adjacent switch apparatus, the openings in 236-1 and 236-2 form a passageway along the Z direction through the three-pole switch 980. A securing pole, such as a bolt, may be passed through the aperture to provide further rigidity and support for the three-pole switch 980.

When the switch apparatuses 930a, 930b, and 930c are connected as shown in FIG. 9B, the three-pole switch 980 is assembled.

The axles 571 of each instance of the moveable contact assembly 570 in the three-pole switch 980 are coupled together and rotate together such that the state of the switch apparatus 930a, 930b, and 930c can be changed or controlled simultaneously.

These and other implementations are within the scope of the claims. For example, FIGS. 9A and 9B show a three-pole switch 980 formed by stacking the three single-pole switch apparatuses 980a, 980b, 980c. Other implementations are possible, and a multi-pole switch of any number of poles may be constructed. For example, a two-pole switch may be formed by stacking two single-pole switch apparatuses (for example, 980a and 980b). Similarly, a four-pole switch may be formed by stacking the switch apparatus 980a, 980b, and two instances of apparatus 980c.

What is claimed is:

1. An electrical switch apparatus comprising:
a base comprising: a first side, a second side opposite the first side, and an opening that passes through the base and is configured to receive a moveable contact assembly; and
geometric features on the second side of the base, the geometric features comprising one or more engagement features that extend from the second side, wherein the one or more engagement features are configured to hold one or more switch components to the base without a separate fastening device.

2. The electrical switch apparatus of claim 1, wherein the geometric features comprise a first engagement feature and a second engagement feature, the first engagement feature is configured to hold a first switch component, the second engagement feature is configured to hold a second switch component.

3. The electrical switch apparatus of claim 3, wherein the geometric features comprise a third engagement feature configured to hold a third switch component, and a fourth engagement feature configured to hold a fourth switch component.

4. The electrical switch apparatus of claim 3, wherein the first switch component comprises a first stationary electrical contact, the second switch component comprises a second stationary electrical contact, the third switch component comprises a first arc chute, and the fourth switch component comprises a second arc chute.

5. The electrical switch apparatus of claim 2, wherein the first switch component comprises a first stationary electrical contact, and the second switch component comprises a second stationary electrical contact.

6. The electrical switch apparatus of claim 2, wherein the first switch component comprises a first arc chute, and the second switch component comprises a second arc chute.

7. The electrical switch apparatus of claim 1, wherein the one or more engagement features interact with the switch component to hold the switch component without a separate fastening device by a frictional engagement, a tight fit, a snap fit, and/or a compression fit between the one or more engagement features and the switch component.

8. The electrical switch apparatus of claim 1, wherein the base is a first base, and the electrical switch further comprises a second base, the second base comprising: a first side, a second side, and an opening configured to receive the moveable contact assembly; and, wherein the second base is identical to the first base.

9. The electrical switch apparatus of claim 8, wherein the second side of the second base comprises geometric features, the geometric features of the second base comprising one or more engagement features that extend from the second side of the second base.

10. The electrical switch apparatus of claim 9, wherein the geometric features of the first base further comprise one or more attachment features that extend from the second side of the first base; the geometric features of the second base further comprise one or more attachment features that extend from the second side of the second base; and the one or more attachment members of the first base are configured to engage with corresponding attachment features of the second base to attach the first base to the second base with the second side of the first base facing the second side of the second base.

11. The electrical switch apparatus of claim 10, wherein, when the first base is attached to the second base; a shaft of the moveable electrical contact assembly extends through the opening in the first base and the opening in the second base and is rotatable relative to the first base and the second base; and the switch component is between the second side of the first base and the second side of the second base.

12. The electrical switch apparatus of claim 8, wherein the first base and the second base are made of electrically insulating material.

13. An electrical switch comprising:
a base structure comprising:
a first switch base comprising: a first external surface, a first internal surface, and first geometric features extending from the first internal side, the first geometric features comprising first attachment features and first engagement features;
a second switch base comprising: a second external surface, a second internal surface, and second geometric features extending from the second internal side, the second geometric features comprising second attachment features and second engagement features; and
at least one switch component in the base structure; wherein
the at least one switch component is held by one or more of the first engagement features and the second engagement features, and the first and second attachment features connect to hold the first switch base to the second switch base with the first internal surface facing the second internal surface.

14. The electrical switch of claim 13, wherein the at least one switch component comprises one or more of a first stationary electrical contact, a second stationary electrical contact, a first arc chute, and a second arc chute.

15. The electrical switch of claim 13, wherein the first switch base and the second switch base comprise an opening configured to receive a shaft of a moveable contact assembly.

16. The electrical switch of claim 15, further comprising the moveable contact assembly, wherein the shaft is inserted through the opening of the first switch base and the opening of the second switch base, the moveable electrical contact extends radially outward from the shaft, and rotating the shaft rotates the moveable electrical contact along an arc in the base structure.

17. The electrical switch of claim 16, wherein the spatial arrangement of the first geometric features and the spatial arrangement of the second geometric features aligns the first stationary contact and the second stationary contact with the moveable contact such that the angular position of the shaft determines whether or not the moveable contact is connected to the first stationary contact and the second stationary contact.

18. A modular switching system comprising:
a first single-pole switch base comprising: a first base body; and first switch components held in the first base body, the first switch components comprising: a first stationary contact, a second stationary contact, a first arc chute, and a second arc chute; and
a first shaft that passes through the first single-pole switch base and is configured to rotate relative to the first base body, the first shaft comprising a moveable contact that extends radially outward from the shaft and rotates through an arc that intersects the first stationary contact and the second stationary contact; wherein
the first single-pole switch base and the first shaft are configured to be connected to one or more other single-pole switch bases that are identical to the first single-pole switch base to form a multi-pole switch.

19. The modular switching system of claim 18, wherein the first switch components are secured to the first base body only with geometric features internal to the first base body.
